(19) United States
(12) Patent Application Publication
(10) Pub. No.: US 2007/0008263 A1
(43) Pub. Date: Jan. 11, 2007

(54) Liquid crystal display

(76) Inventor: Dong-Gyu Kim, Yongin-si (KR)

Correspondence Address: MacPherson Kwok Chen & Heid LLP, 1762 Technology Drive, Suite 226, San Jose, CA, 95110, US

(21) Appl. No.: 11/412,595

(22) Filed: Apr. 26, 2006

(30) Foreign Application Priority Data
Apr. 26, 2005 (KR) 10-2005-0034412

(51) Int. Cl. G09G 3/36

(52) U.S. Cl. 345/87

(57) ABSTRACT

A liquid crystal display includes a plurality of pixels arranged in the form of a matrix and having first and second sub-pixels. A plurality of gate lines are connected to the first and second sub-pixels to transmit gate signals thereto. A plurality of first and second data lines cross the gate lines, and are connected to the first and second sub-pixels to transmit first and second data voltages thereto, respectively. A data driver outputs the first and second data voltages to the first and second data lines, respectively. The first and second data voltages have the same polarity. A pixel is divided into two sub-pixels, and different data voltages are separately applied to the two sub-pixels, thereby enhancing visibility.

### CROSS-REFERENCE TO RELATED APPLICATIONS

The present application claims priority from Korean Patent Application No. 2005-0034412, filed on Apr. 26, 2005, the disclosure of which is hereby incorporated herein by reference in its entirety.

### BACKGROUND OF THE INVENTION

1. Field of the Invention

The present invention relates to a liquid crystal display.

2. Description of the Related Art

A liquid crystal display (“LCD”), one of the most extensively used flat panel display devices, includes two display panels with field-generating electrodes such as pixel and common electrodes mounted thereon, and a liquid crystal layer sandwiched therebetween. The LCD generates an electric field in the liquid crystal layer by applying voltages to the field-generating electrodes, which aligns the liquid crystal molecules of the liquid crystal layer to control the polarization of light incident thereto, thereby causing an image to be displayed. With the LCD, two electrodes generate the electric field in the liquid crystal layer upon receipt of voltages, and the electric field is varied in intensity to control the transmittance of the light passing through the liquid crystal layer and obtain the desired images. In order to prevent the liquid crystal layer from deteriorating due to the long-termed application of a mono-directional electric field, the polarity of a data voltage with respect to a common voltage is inverted for respective frames, pixel rows, or pixels.

Use of the vertically aligned (“VA”) mode LCD has become widespread because it gives a high contrast ratio and a wide reference viewing angle. In the VA mode LCD, the liquid crystal molecules are aligned vertically in the upper and lower panels without the application of an electric field. The reference viewing angle refers to a viewing angle with a contrast ratio of 1:10, or an inter-gray luminance inversion limit angle.

With the VA mode LCD, cut portions or protrusions may be formed at the field-generating electrodes to realize a wide viewing angle. As the direction of the liquid crystal molecules to be inclined is determined by way of the cut portions or protrusions, the inclination directions of the liquid crystal molecules can be diversified, thereby widening the reference viewing angle.

However, the lateral side of a VA mode LCD has poor visibility compared to its front side. For example, the luminance of a patterned vertically aligned (PVA) mode LCD having cut portions is greater toward its lateral side, and in a serious case, the luminance difference between the high grays is eradicated so that the display image may appear to be distorted.

In order to enhance the lateral side visibility, it has been proposed that a pixel should be divided into two sub-pixels, which are capacitor-combined with each other. A voltage is directly applied to one of the sub-pixels, and a voltage drop is caused at the other sub-pixel due to the capacitor combination. In this way, the two sub-pixels are differentiated in voltage from each other and have different light transmittances.

However, with such a method, the light transmittances of the two sub-pixels cannot be adequately controlled to the desired level, and in particular, the light transmittance is differentiated for respective colors. Therefore, the voltages cannot be differently adjusted with respect to the respective colors. Furthermore, the aperture ratio is degraded due to the addition of a conductor for the capacitor combination, and the light transmittance is reduced due to the capacitor combination induced voltage drop.

### SUMMARY OF THE INVENTION

In order to provide a liquid crystal display with enhanced lateral side visibility and reasonable light transmittance, the pixels are arranged in the form of a matrix having first and second sub-pixels; a plurality of gate lines connected to the first and second sub-pixels to transmit gate signals thereto; a plurality of first and second data lines crossing the gate lines and connected to the first and second sub-pixels to transmit first and second data voltages thereto, respectively; and a data driver for outputting the first and second data voltages to the first and second data lines, respectively; wherein the first and second data voltages have the same polarity.

Advantageously, the first and second data lines may be placed at each end of the pixel, the plurality of first and second data lines may be sequentially connected to the data driver and the data driver may output the first and second data voltages such that the polarities thereof are inverted every two output terminals.

With pairs of a first and a second data line disposed between pixel neighbors, at least a pair of the first and second data lines may be connected to the data driver in a crossed manner. The data driver may output the first and second data voltages such that the polarities thereof are inverted for each consecutive output terminal.

### BRIEF DESCRIPTION OF THE DRAWING

The present invention will become more apparent by describing embodiments thereof in detail with reference to the accompanying drawings, in which:

FIG. 1 is a block diagram of an LCD according to an embodiment of the present invention;

FIG. 2 is an equivalent circuit diagram of a pixel of an LCD according to an embodiment of the present invention;

FIG. 3 is an equivalent circuit diagram of a sub-pixel of an LCD according to an embodiment of the present invention;

FIG. 4 is a plan view of a thin film transistor panel for an LCD according to an embodiment of the present invention;

FIG. 5 is a plan view of a common electrode panel for an LCD according to an embodiment of the present invention;

FIG. 6 is a plan view of a liquid crystal panel assembly with the thin film transistor panel shown in FIG. 4 and the common electrode panel shown in FIG. 5;

FIGS. 7A and 7B are cross-sectional views of the liquid crystal panel assembly taken along the VIIa-VIIa line and the VIIb-VIIb line of FIG. 6;

FIGS. 8A and 8B schematically illustrate driver inversion and apparent inversion with an LCD according to an embodiment of the present invention;

FIG. 9 is a timing diagram of various kinds of signals for an LCD according to an embodiment of the present invention;

FIG. 10 is a block diagram of an LCD according to another embodiment of the present invention;

FIG. 11 is a plan view of a thin film transistor panel for an LCD according to another embodiment of the present invention;

FIG. 12 is a cross-sectional view of the thin film transistor panel taken along the XII-XII line of FIG. 11;

FIGS. 13A and 13B schematically illustrate driver inversion and apparent inversion with an LCD according to another embodiment of the present invention;

FIG. 14 is a block diagram of an LCD according to another embodiment of the present invention;

FIG. 15 is a plan view of a thin film transistor panel for an LCD according to another embodiment of the present invention; and

FIGS. 16A and 16B schematically illustrates driver inversion and apparent inversion with an LCD according to another embodiment of the present invention.

### DETAILED DESCRIPTION OF THE PREFERRED EMBODIMENTS

The present invention will be described more fully hereinafter with reference to the accompanying drawings, in which preferred embodiments of the invention are shown. The present invention may, however, be embodied in many different forms and should not be construed as limited to the embodiments set forth herein. In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present. In contrast, when an element is referred to as being “directly on” another element, there are no intervening elements present.

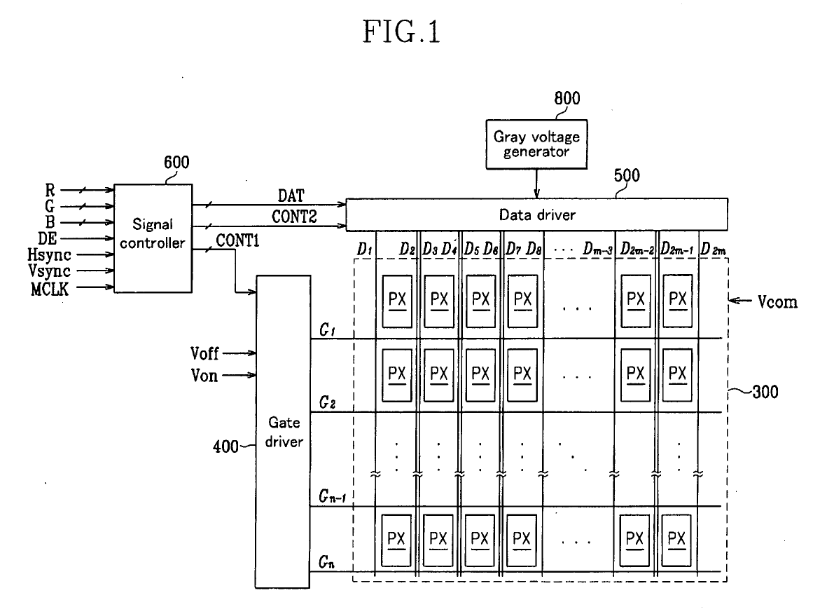

As shown in FIG. 1, an LCD according to an embodiment of the present invention includes a liquid crystal panel assembly 300, gate and data drivers 400 and 500 connected to the liquid crystal panel assembly 300, a gray voltage generator 800 connected to the data driver 500, and a signal controller 600 for controlling them.

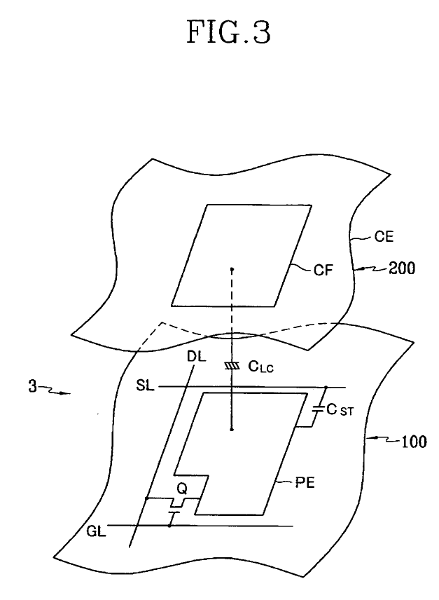

From the perspective of an equivalent circuit, the liquid crystal panel assembly 300 includes a plurality of display signal lines G₁-Gₙ and D₁-D₂ₘ, and a plurality of pixels PX connected to those lines and arranged in the form of a matrix. By contrast, from the perspective of physical structure, shown in FIG. 3, the liquid crystal panel assembly 300 includes a thin film transistor panel 100 and a common electrode panel 200 facing each other, and a liquid crystal layer 3 disposed between the two panels.

The display signal lines G₁-Gₙ and D₁-D₂ₘ include a plurality of gate lines G₁-Gₙ for transmitting gate signals (also called “scanning signals”), and data lines D₁-D₂ₘ for transmitting data signals. The gate lines G₁-Gₙ extend in the direction of pixel rows parallel to each other, and the data lines D₁-D₂ₘ extend in the direction of pixel columns parallel to each other. A pair of data lines D₁-D₂ₘ are placed at each side of a pixel PX, respectively.

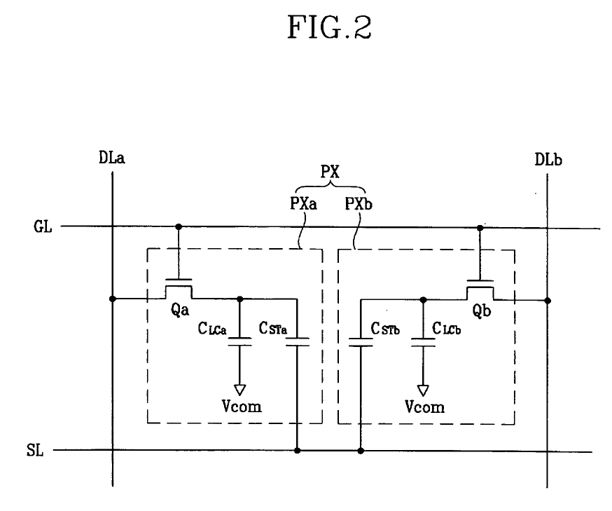

FIG. 2 illustrates an equivalent circuit of the display signal lines and a pixel PX. The display signal lines include a gate line indicated by GL, data lines indicated by DLa and DLb, and a storage electrode line SL extended parallel to the gate line GL. The respective pixels PX have a pair of sub-pixels PXa and PXb, and the sub-pixels PXa and PXb include switching elements Qa and Qb connected to the relevant gate line GL and data lines DLa and DLb, liquid crystal capacitors C_{LCa} and C_{LCb} connected to the switching elements Qa and Qb, and storage capacitors C_{STa} and C_{STb}, respectively. When needed, the storage capacitors C_{STa} and C_{STb} may be omitted.

As shown in FIG. 3, the switching element Q of the respective sub-pixels PXa and PXb is formed with a thin film transistor provided at the thin film transistor panel 100. The switching element Q is a triode device with a control terminal connected to the gate line GL, an input terminal connected to the data line DL, and an output terminal connected to the liquid crystal capacitor CLC and the storage capacitor C_{ST}.

The liquid crystal capacitor C_{LC} is comprised of the sub-pixel electrode PE of the thin film transistor panel 100 and the common electrode CE of the common electrode panel 200 as its two terminals, and the liquid crystal layer 3 disposed between the two electrodes PE and CE which functions as the dielectric. The sub-pixel electrode PE is connected to the switching element Q, and the common electrode CE is formed on the entire surface of the common electrode panel 200 to receive a common voltage Vcom. Alternatively to the structure shown in FIG. 3, the common electrode CE may be provided at the thin film transistor panel 100, and in this case, either one of the two electrodes PE and CE may be formed in the shape of a line or a bar.

The storage capacitor C_{ST} that is subsidiary to the liquid crystal capacitor C_{LC} is formed by overlapping the storage electrode line SL provided at the thin film transistor panel 100 with the sub-pixel electrode PE while interposing an insulator, and a predetermined voltage such as a common voltage Vcom is applied to the storage electrode line SL. Alternatively, the storage capacitor C_{ST} may be formed by overlapping the sub-pixel electrode PE with the immediately previous gate line while interposing an insulator.

To display color, the respective pixels should intrinsically express one of the primary colors (spatial division), or alternately express the primary colors in a temporal order (time division) such that the desired colors can be perceived by the spatial and temporal sum of the primary colors. The primary colors include red, green, and blue colors. FIG. 3 shows an example of the spatial division where each pixel has a color filter CF expressing one of the primary colors at the region of the common electrode panel 200. Unlike with the structure shown in FIG. 3, the color filter CF may be formed over or under the sub-pixel electrode PE of the thin film transistor panel 100.

As shown in FIG. 1, the gray voltage generator 800 generates two sets of gray voltages related to the light transmittance of the sub-pixels PXa and PXb. One of the two sets of gray voltages has a positive value with respect to the common voltage Vcom, and the other has a negative value. The gate driver 400 is connected to the gate lines G₁-Gₙ of the liquid crystal panel assembly 300 to apply gate signals with combinations of gate-on and gate-off voltages Von and Voff from the outside to the gate lines G₁Gₙ. The data driver 500 is connected to the data lines D₁-D₂ₘ of the liquid crystal panel assembly 300 to select the gray voltages from the gray voltage generator 800, and apply them to the sub-pixels PXa and PXb as data signals. The gate driver 400 or the data driver 500 is directly mounted on the liquid crystal panel assembly 300 in the form of one or more driving integrated circuit chips, or is mounted on a flexible printed circuit film (not shown) and attached to the liquid crystal panel assembly 300 in the form of a tape carrier package (TCP). By contrast, the gate driver 400 or the data driver 500 may be integrated into the liquid crystal panel assembly 300. The signal controller 600 controls the operation of the gate and data drivers 400 and 500.

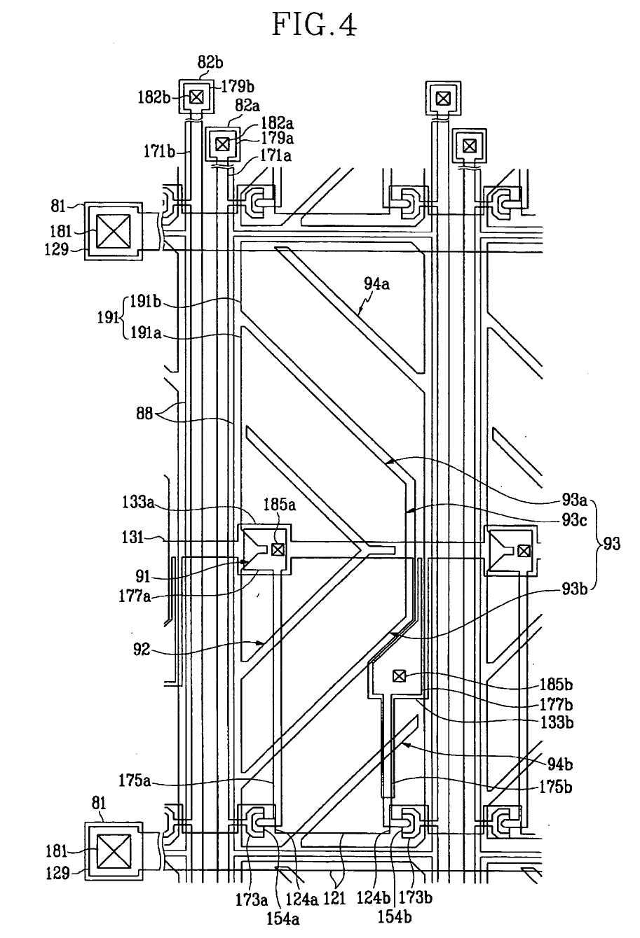

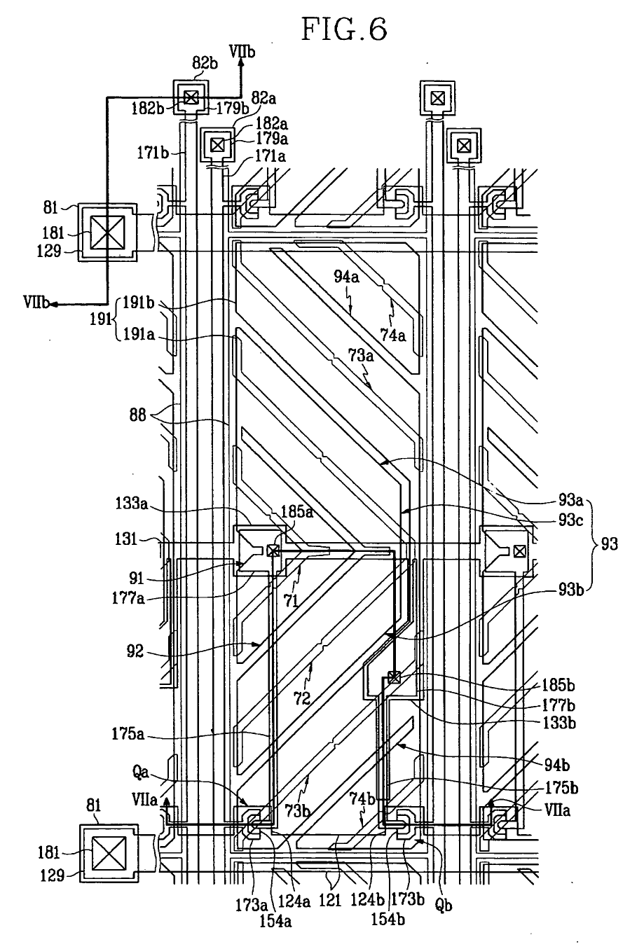

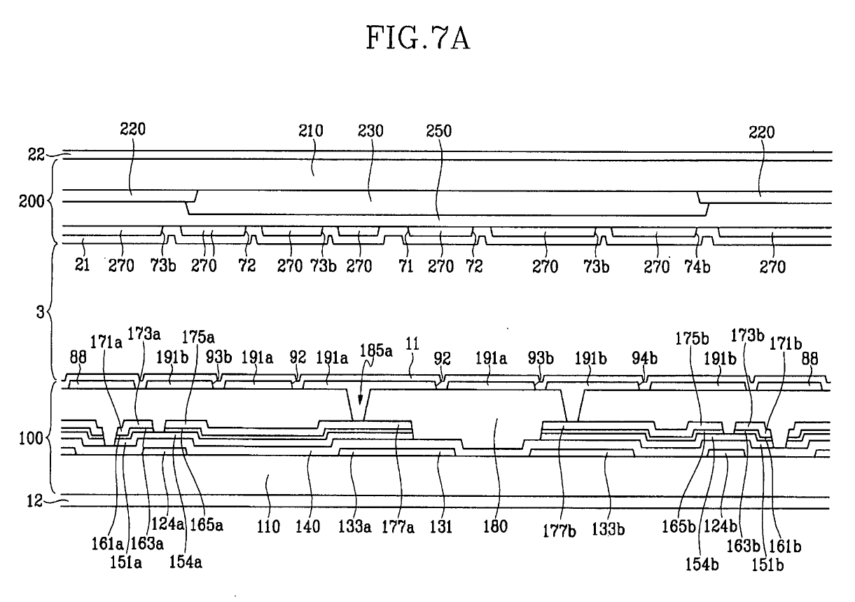

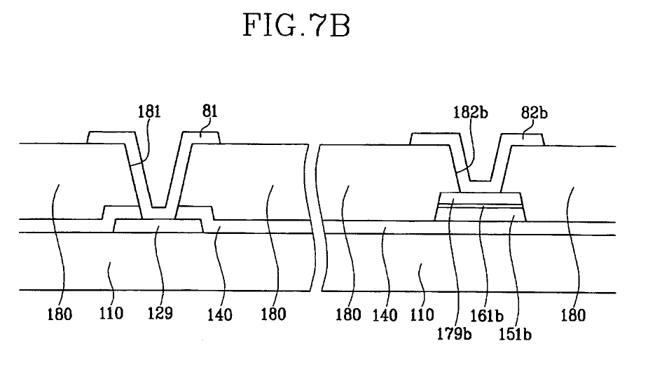

The thin film transistor panel 100 will be first specifically explained with reference to FIGS. 4, 6, 7A, and 7B. A plurality of gate lines 121 and a plurality of storage electrode lines 131 are formed on an insulating substrate 110 based on transparent glass. The gate lines 121 extend horizontally, and are separated from each other to transmit gate signals. The gate lines 121 have a plurality of protrusions for forming a plurality of gate electrodes 124a and 124b, and wide area end portions 129 to be connected to other layers or external driving circuits.

The storage electrode lines 131 extend horizontally, and have a plurality of protrusions for forming storage electrodes 133a and 133b. The first storage electrode 133a is rectangular-shaped to be symmetrical to the storage electrode line 131. The second storage electrode 133b has a protrusion that is vertically extended from the storage electrode line 131, and an extension that is further extended from the protrusion. A predetermined voltage is applied to the storage electrode line 131, such as a common voltage Vcom that is applied to a common electrode 270 of the common electrode panel 200.

The gate lines 121 and the storage electrode lines 131 are formed with an aluminum-based metallic material such as aluminum (Al) and an aluminum alloy, a silver-based metallic material such as silver (Ag) and a silver alloy, a copper-based metallic material such as copper (Cu) and a copper alloy, a molybdenum-based metallic material such as molybdenum (Mo) and a molybdenum alloy, chromium (Cr), titanium (Ti), or tantalum (Ta). Alternatively, the gate lines 121 and the storage electrode lines 131 may have a multi-layered structure with two conductive layers (not shown) that are differentiated in physical properties thereof. One of the conductive layers is formed with a low-resistivity metallic material such as an aluminum-based metallic material, a silver-based metallic material and a copper-based metallic material such that it can reduce the signal delay or voltage drop of the gate lines 121 and the storage electrode lines 131. By contrast, the other conductive layer is formed with a material having an excellent contact characteristic with respect to other materials like indium tin oxide ITO and indium zinc oxide IZO, such as a molybdenum-based metallic material, chromium, titanium, and tantalum. Good examples of such a combination are a structure with a chromium-based underlayer and an aluminum (alloy)-based overlayer, and a structure with an aluminum (alloy)-based underlayer and a molybdenum (alloy)-based overlayer. In addition, the gate lines 121 and the storage electrode lines 131 may be formed with various other kinds of metallic materials and conductors.

The lateral sides of the gate lines 121 and the storage electrode lines 131 are inclined with respect to the surface of the substrate 110, preferably at 30 to 80°. A gate insulating layer 140 is formed on the gate lines 121 and the storage electrode lines 131 with silicon nitride (SiNₓ). A plurality of linear-shaped semiconductors 151a and 151b are formed on the gate insulating layer 140 with hydrogenated amorphous silicon (abbreviated as a-Si) or polysilicon. The linear-shaped semiconductors 151a and 151b extend vertically, and a plurality of projections 154a and 154b are projected from the semiconductors 151a and 151b toward the gate electrodes 124a and 124b, respectively.

A plurality of linear-shaped and island-shaped ohmic contacts 161a, 161b, 165a, and 165b are formed on the semiconductors 151a and 151b with silicide, or n+ hydrogenated amorphous silicon where n-type impurities such as phosphorous are doped at a high concentration. The linear-shaped ohmic contacts 161a and 161b have a plurality of protrusions 163a and 163b, respectively. A pair of the protrusions 163a and 163b and a pair of island-shaped ohmic contacts 165a and 165b are placed on the projections 154a and 154b of the semiconductors 151a and 151b, respectively.

The lateral sides of the semiconductors 151a and 151b and the ohmic contacts 161a, 161b, 165a, and 165b are inclined against the surface of the substrate 110 at 30 to 80°. Pairs of first and second data lines 171a and 171b and pairs of first and second drain electrodes 175a and 175b are formed on the ohmic contacts 161a, 161b, 165a, and 165b, and on the gate insulating layer 140. The data lines 171a and 171b extend vertically, and cross the gate line 121 and the storage electrode line 131 to transmit data voltages. The data lines 171a and 171b include a plurality of source electrodes 173a and 173b extended toward the gate electrodes 124a and 124b, and end portions 179a and 179b amplified in width to make a connection with other layers or external driving circuits.

The drain electrodes 175a and 175b are separated from the data lines 171a and 171b, and face the source electrodes 173a and 173b around the gate electrodes 124a and 124b, respectively. The first and second drain electrodes 175a and 175b have bar-shaped end portions placed on the projections 154a and 154b of the semiconductors 151a and 151b, and extensions 177a and 177b extended from the bar-shaped end portions and overlapped with the storage electrodes 133a and 133b with a wide area. The bar-shaped end portions of the first and second drain electrodes 175a and 175b are partially surrounded by the U-bent source electrodes 173a and 173b.

The first and second gate electrodes 124a and 124b, the first and second source electrodes 173a and 173b, and the first and second drain electrodes 175a and 175b form first and second thin film transistors (TFTs) Qa and Qb together with the projections 154a and 154b of the semiconductors 151a and 151b. The channels of the thin film transistors. Qa and Qb are formed at the semiconductors 154a and 154b between the first and second source electrodes 173a and 173b and the first and second drain electrodes 175a and 175b, respectively.

The data lines 171a and 171b and the drain electrodes 175a and 175b are preferably formed with a refractory metal such as molybdenum, chromium, tantalum, and titanium, or alloys thereof, or may involve a multi-layered structure with a refractory metallic layer (not shown) and a low resistance conductive layer (not shown). Examples of the multi-layered structure are a double-layered structure with a chromium or molybdenum (alloy)-based underlayer and an aluminum (alloy)-based overlayer, and a triple-layered structure with a molybdenum (alloy)-based underlayer, an aluminum (alloy)-based middle layer, and a molybdenum (alloy)-based overlayer. In addition, the data lines 171 and the drain electrodes 175a and 175b may be formed with various other materials or conductors.

As with the gate lines 121 and the storage electrode lines 131, the lateral sides of the data lines 171a and 171b and the drain electrodes 175a and 175b are inclined at 30 to 80°, respectively.

The distance between the two neighboring data lines 171a and 171b is minimized in consideration of processing capacity and production yield, thereby minimizing a reduction in aperture ratio due to an increase in the number of data lines 171a and 171b.

The ohmic contacts 161a, 161b, 165a, and 165b only exist between the underlying semiconductors 151a and 151b and the overlying data lines 171a and 171b and drain electrodes 175a and 175b to lower the contact resistance therebetween. The linear-shaped semiconductors 151a and 151b have nearly the same shape as the data lines 171a and 171b and drain electrodes 175a and 175b and the underlying ohmic contacts 161a, 161b, 165a, and 165b, except that they have portions exposed through the source electrodes 173a and 173b and the drain electrodes 175a and 175b.

A passivation layer 180 is formed on the data lines 171a and 171b, the drain electrodes 175a and 175b, and the exposed portions of the semiconductors 151a and 151b. The passivation layer 180 is formed with an inorganic insulating material such as silicon nitride and silicon oxide, an organic insulating material, or a low dielectric insulating material. The organic insulating material and the low dielectric insulating material preferably have a dielectric constant of 4.0 or less, and examples of the low dielectric insulating material are a-Si:C:O and a-Si:O:F formed through plasma enhanced chemical vapor deposition (PECVD). The passivation layer 180 may be formed with an organic insulating material having photosensitivity, and the surface of the passivation layer 180 may be flattened. Alternatively, the passivation layer 180 may have a double-layered structure with an inorganic underlayer and an organic overlayer such that it bears the excellent insulating characteristic of the organic layer and does not harm the exposed portions of the semiconductors 151a and 151b.

A plurality of contact holes 182a, 182b, 185a, and 185b are formed at the passivation layer 180 such that they expose the end portions 179a and 179b of the data lines 171a and 171b and the extensions 177a and 177b of the drain electrodes 175a and 175b, respectively. A plurality of contact holes 181 are formed at the passivation layer 180 and the gate insulating layer 140 such that they expose the end portions 129 of the gate lines 121. A plurality of pixel electrodes 191 with first and second sub-pixel electrodes 191a and 191b, shielding electrodes 88 and a plurality of contact assistants 81, 82a, and 82b are formed on the passivation layer 180 with a transparent conductive material such as ITO and IZO, or a reflective metallic material such as aluminum, silver, and alloys thereof.

The first and second sub-pixel electrodes 191a and 191b are physically and electrically connected to the first and second drain electrodes 175a and 175b through the contact holes 185a and 185b to receive data voltages from the first and second drain electrodes 175a and 175b. Different predetermined voltages are applied to a pair of the sub-pixel electrodes 191a and 191b with respect to one input image signal, and the dimensions thereof are determined depending upon the size and shape of the sub-pixel electrodes 191a and 191b. Furthermore, the areas of the sub-pixel electrodes 191a and 191b may differ from each other. For instance, the second sub-pixel electrode 191b receives a voltage that is higher than the voltage applied to the first sub-pixel electrode 191a, and is smaller in area than the first sub-pixel electrode 191a.

Upon receipt of the data voltages, the sub-pixel electrodes 191a and 191b generate electric fields together with the common electrode 270, and align the liquid crystal molecules of the liquid crystal layer 3 between the two electrodes 191a and 191b and the common electrode 270.

As explained earlier, the respective sub-pixel electrodes 191a and 191b and the common electrode 270 form liquid crystal capacitors C_{LCa} and C_{LCb} and sustain the voltages applied thereto even after the thin film transistors Qa and Qb turn off. Storage capacitors C_{STa} and C_{STb} are connected to the liquid crystal capacitors C_{LCa} and C_{LCb} in parallel to reinforce the voltage storage capacity. The storage capacitors C_{STa} and C_{STb} are formed by overlapping the first and second sub-pixel electrodes 191a and 191b and the extensions 177a and 177b of the drain electrodes 175a and 175b connected thereto with the storage electrodes 133a and 133b.

The respective pixel electrodes 191 are outlined roughly with a rectangular shape, and are edge-cut at the right corners thereof. The edge-cut oblique side is angled against the gate line 121 at 45°. A pair of the first and the second sub-pixel electrodes 191a and 191b forming one pixel electrode 191 engage with each other while interposing a gap 93. The first sub-pixel electrode 191a is shaped as a rotated equilateral trapezoid, and has a left side placed around the storage electrode 133a, a right side placed opposite to the left side, and upper and lower oblique sides angled against the gate line 121 at 45°. The second sub-pixel electrode 191b includes a pair of trapezoids facing the oblique sides of the first sub-pixel electrode 191a, and a vertical portion facing the right side of the first sub-pixel electrode 191a. Accordingly, the gap 93 between the first and second sub-pixel electrodes 191a and 191b has upper and lower inclined portions 93a and 93b angled against the gate line 121 roughly at 45° with an even width, and a vertical portion 93c with a substantially even width.

For explanatory convenience, the gap 93 will be referred to as the cut portion. The pixel electrode 191 has middle cut portions 91 and 92, upper cut portions 93a and 94a, and lower cut portions 93b and 94b. The pixel electrode 191 is partitioned into a plurality of domains by way of the cut portions 91, 92, 93a, 93b, 94a, and 94b. The cut portions 91, 92, 93a, 93b, 94a, and 94b are nearly inversion-symmetrical to the storage electrode line 131. The upper and lower cut portions 93a, 93b, 94a, and 94b obliquely extend from the left side of the pixel electrode 191 toward the right side thereof, and are respectively placed at the upper half and the lower half of the pixel electrode 191 around the storage electrode line 131, which bisects the pixel electrode 191 horizontally. The upper and the lower cut portions 93a, 93b, 94a, and 94b extend vertical to each other while being angled against the gate line 121 at 45°. The middle cut portions 91 and 92 are formed with a pair of branches proceeding parallel to the upper cut portions 93a and 94a and the lower cut portions 93b and 94b. The middle cut portions 91 and 92 have a horizontal portion horizontally extended at their center, respectively.

Accordingly, the upper half and the lower half of the pixel electrode 191 are divided into four domains by way of the cut portions 91, 92, 93a, 93b, 94a, and 94b, respectively. The number of divided domains or cut portions is varied depending upon design factors such as pixel size, the horizontal to vertical side length ratio of the pixel electrode 191, and the kind or characteristic of the liquid crystal layer 3. The pixel electrode 191 is overlapped with the gate line 121 neighboring thereto to thereby enhance the aperture ratio. The shielding electrode 88 has vertical portions proceeding along the data lines 171a and 171b, and a horizontal portion proceeding along the gate line 121. The vertical portions of the shielding electrode 88 completely cover the data lines 171a and 171b, and the horizontal portion thereof is placed internal to the boundary of the gate line 121. The shielding electrode 88 may be connected to the storage electrode line 131 through contact holes (not shown) of the passivation layer 180 and the gate insulating layer 140, or to a short point (not shown) for relaying the common voltage Vcom from the thin film transistor panel 100 to the common electrode panel 200.

The shielding electrode 88 receives the common voltage Vcom, and shields the electric fields formed between the data lines 171a and 171b and the pixel electrode 191 as well as between the data lines 171a and 171b and the common electrode 270, thereby preventing a voltage distortion of the pixel electrode 191 and a signal delay of the data voltage transmitted by the data lines 171a and 171b. The pixel electrode 191 and the shielding electrode 88 should be spaced apart from each other by a distance to prevent them from being short-circuited with each other. Therefore, the pixel electrode 191 goes far from the data lines 171a and 171b so that the parasitic capacitance therebetween is reduced.

Since the permittivity of the liquid crystal layer 3 is higher than that of the passivation layer 180, with the absence of the shielding electrode 88, the parasitic capacitance between the data lines 171a and 171b and the shielding electrode 88 is smaller than that between the data lines 171a and 171b and the common electrode 270. Moreover, as the pixel electrode 191 and the shielding electrode 88 are formed with the same layer, the distance therebetween is evenly held, and accordingly, the parasitic capacitance therebetween is sustained in a constant manner. In order to minimize the reduction in aperture ratio, the distance between the shielding electrode 88 and the pixel electrode 191 is preferably minimized. However, when needed, such a shielding electrode 88 may be omitted.

The contact assistants 81, 82a, and 82b are connected to the end portion 129 of the gate line 121 and the end portions 179a and 179b of the data lines 171a and 171b through the contact holes 181, 182a, and 182b, respectively. The contact assistants 81, 82a, and 82b serve to reinforce the adhesion between the exposed end portion 129 of the gate line 121 and the exposed end portions 179a and 179b of the data lines 171a and 171b and external devices, and protect them.

If the gate driver 400 or the data driver 500 shown in FIG. 1 is integrated on the thin film transistor panel 100, the gate line 121 or the data lines 171a and 171b may be elongated to directly connect with the gate driver 400 or the data driver. In this case, the contact assistants 81, 82a, and 82b may be used to interconnect the gate line 121 or the data lines 171a and 171b and those drivers 400 and 500. An alignment layer 11 is formed on the pixel electrode 191, the contact assistants 81, 82a, and 82b and the passivation layer 180 to align the liquid crystal layer 3. The alignment layer 11 may be a horizontal alignment layer.

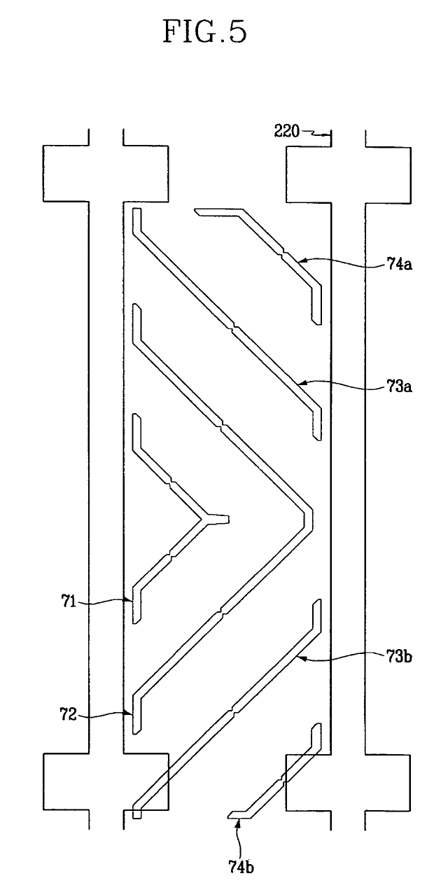

The common electrode panel 200 will now be specifically explained with reference to FIGS. 5 to 7A. A light blocking member 220, called the black matrix, is formed on an insulating substrate 210 based on transparent glass to prevent leakage of light. The light blocking member 220 faces the pixel electrode 191, and has a plurality of opening portions with nearly the same shape as the pixel electrode 191. Alternatively, the light blocking member 220 may be formed with portions corresponding to the data lines 171a and 171b, and portions corresponding to the thin film transistors Qa and Qb. However, the light blocking member 220 may be formed with various shapes to prevent the leakage of light around the pixel electrode 191 and the thin film transistors Qa and Qb.

A plurality of color filters 230 are formed on the substrate 210. The color filters 230 are mostly placed within the region surrounded by the light blocking member 220, and they vertically and longitudinally extend along the pixel electrode 191. The color filters 230 may express one of the three primary colors of red, green, and blue. An overcoat 250 is formed on the color filters 230 and the light blocking member 220 to prevent the color filters 230 from being exposed, and provide a flattened surface.

A common electrode 270 is formed on the overcoat 250 with a transparent conductive material such as ITO and IZO. The common electrode 270 has a plurality of sets of cut portions 71-74b. A set of the cut portions 71-74b face one pixel electrode 191, and include middle cut portions 71 and 72, upper cut portions 73a and 74a, and lower cut portions 73b and 74b. The cut portions 71-74b are arranged between the neighboring cut portions 91-94b of the pixel electrode 191 as well as between the peripheral cut portions 94a and 94b and the oblique sides of the pixel electrode 191. Furthermore, the respective cut portions 71-74b include at least one inclined portion extended parallel to the cut portions 91-94b of the pixel electrode 191.

The lower and upper cut portions 73a-74b include an inclined portion extended from the right side of the pixel electrode 191 toward the bottom or the top side thereof, and horizontal and vertical portions extended from the respective ends of the inclined portion along the sides of the pixel electrode 191 while being overlapped with those sides and obtuse-angled against the inclined portion.

The first middle cut portion 71 has a horizontal center portion roughly extended from the left side of the pixel electrode 191 in the horizontal direction, a pair of inclined portions obliquely extended from the end of the horizontal center portion to the left side of the pixel electrode 191, and vertical end portions extended from the ends of the inclined portions along the left side of the pixel electrode 191 while being overlapped with the left side and obtuse-angled against the inclined portions.

The second middle cut portion 72 includes a vertical portion roughly extended along the right side of the pixel electrode 191 while being overlapped therewith, a pair of inclined portions extended from the respective ends of the vertical portion toward the left side of the pixel electrode 191, and vertical end portions extended from the ends of the inclined portions along the left side of the pixel electrode 191 while being overlapped with the left side and obtuse-angled against the inclined portions.

Triangle-shaped notches are formed at the inclined portions of the cut portions 71-74b. The notches may be formed in the shape of a rectangle, a trapezoid, or a semi-circle, or they may be concave or convex. The notches determine the arrangement of the liquid crystal molecules of the liquid crystal layer 3 located at the regional boundary corresponding to the cut portions 71-74b. The number of the cut portions 71-74b may be varied depending upon design factors, and the light blocking member 220 may be overlapped with the cut portions 71-74b to prevent the leakage of light around the cut portions 71-74b.

As the same common voltage is applied to the common electrode 270 and the shielding electrode 88, an electric field does not exist between those electrodes. Accordingly, the liquid crystal molecules disposed between the common electrode 270 and the shielding electrode 88 continuously hold the initial vertical alignment state thereof, and the light incident thereto is intercepted.

An alignment layer 21 is formed on the common electrode 270 and the overcoat 250 to align the liquid crystal layer 3. The alignment layer 21 may be a horizontal alignment layer.

Polarizers 12 and 22 are provided on the outer surfaces of the panels 100 and 200, and the light transmission axes of the two polarizers 12 and 22 proceed perpendicular to each other. One of the light transmission axes of the two polarizers 12 and 22 (or the light absorption axis thereof) proceeds in the horizontal direction. In the case of a reflection type of LCD, one of the two polarizers 12 and 22 may be omitted.

The liquid crystal layer 3 has negative dielectric anisotropy, and the liquid crystal molecules of the liquid crystal layer 3 have directors that are vertically aligned with respect to the surfaces of the two panels with no application of a voltage. When a common voltage is applied to the common electrode 270 and a data voltage is applied to the pixel electrode 191, an electric field is generated nearly vertical to the surfaces of the panels 100 and 200. The cut portions 91-94b and 71-74b of the electrodes 191 and 270 deform such an electric field, and form components that are vertical to the sides of the cut portions 91-94b and 71-74b. Accordingly, the electric field is inclined with respect to the direction vertical to the surfaces of the panels 100 and 200. The liquid crystal molecules are aligned in response to the electric field such that the directors thereof proceed vertical to the electric field.

At this time, the electric fields formed around the cut portions 91-94b and 71-74b and the sides of the pixel electrode 191 do not proceed parallel to the directors of the liquid crystal molecules but are angled against the latter at a predetermined angle. Therefore, the liquid crystal molecules are rotated on the plane between the directors of the liquid crystal molecules and the electric fields in the direction with a short movement distance. Consequently, a set of the cut portions 91-94b and 71-74b and the sides of the pixel electrode 191 partition the portion of the liquid crystal layer 3 placed on the pixel electrode 191 into a plurality of domains where the inclination directions of the liquid crystal molecules differ from each other, and hence, the reference viewing angle is enlarged. At least one of the cut portions 91-94b and 71-74b may be replaced by a protrusion or a hollowed portion, and the shape and arrangement of the cut portions 91-94b and 71-74b may be varied.

The display operation of the above-structured LCD will now be explained in detail. As shown in FIG. 1, the signal controller 600 receives input image signals R, G, and B and input control signals for controlling the displaying thereof from an external graphics controller (not shown), such as vertical synchronization signals Vsync, horizontal synchronization signals Hsync, main clock signals MCLK, and data enable signals DE. The signal controller 600 suitably processes the image signals R, G, and B pursuant to the operation conditions of the liquid crystal panel assembly 300, based on the input image signals R, G, and B and the input control signals, and generates gate control signals CONT1 and data control signals CONT2. The signal controller 600 transmits the gate control signals CONT1 to the gate driver 400, and the data control signals CONT2 and the processed image signals DAT to the data driver 500. The conversion of the image signals is done through mapping that is predetermined by experiments and recorded in a lookup table (not shown), or through the operation of the signal controller 600.

The gate control signals CONT1 include scanning start signals STV for instructing to start the scanning of the gate-on voltage Von, gate clock signals CPV for controlling the output timing of the gate-on voltage Von, and output enable signals OE for defining the width of the gate-on voltage Von. The data control signals CONT2 include horizontal synchronization start signals STH for informing of the data transmission to one row of sub-pixels PXa and PXb, load signals LOAD for applying the relevant data voltages to the data lines D1-D2m, and data clock signals HCLK. Furthermore, the data control signals CONT2 include reverse signals RVS for inverting the polarity of the data voltage with respect to the common voltage Vcom (referred to hereinafter as “the polarity of the data voltage”).

The data driver 500 receives and shifts image data DAT for a row of sub-pixels PXa and Pxb in accordance with the data control signals CONT2 from the signal controller 600. The data driver 500 selects the gray voltages corresponding to the respective image data DAT among the gray voltages from the gray voltage generator 800, and suitably converts the image data DAT into analog data voltages to apply them to the relevant data lines D1-D2m. The gate driver 400 applies the gate-on voltages Von to the gate lines G1-Gn in accordance with the gate control signals CONT1 from the signal controller 600 to turn on the switching elements Qa and Qb connected to the gate lines G1-Gn, and accordingly, the data voltages applied to the data lines D1-D2m are applied to the relevant sub-pixels PXa and PXb via the turned-on switching elements Qa and Qb.

The difference between the data voltage applied to the sub-pixels PXa and PXb and the common voltage Vcom is represented by the charge voltage of the respective liquid crystal capacitors CLCa and CLCb, that is, by the sub-pixel voltage. The liquid crystal molecules are reoriented depending upon the dimensions of the sub-pixel voltages, and accordingly, the polarization of the light passing through the liquid crystal layer 3 is varied. The polarization variation is represented by the variation in light transmittance by way of the polarizers 12 and 22 attached to the panels 100 and 200.

One input image data is converted into a pair of output image data, which grant different light transmittances to a pair of the sub-pixels PXa and PXb. Accordingly, the two sub-pixels PXa and PXb indicate different gamma curves, and the gamma curve of one pixel PX becomes a mixture curve thereof. The front side mixture gamma curve corresponds to the optimally-determined front side reference gamma curve, and the lateral side mixture gamma curve is established to be closest to the front side reference gamma curve. In this way, the image data are converted, and the lateral side visibility is enhanced. Furthermore, as explained earlier, the area of the second sub-pixel electrode 191b that receives a relatively high voltage may be established to be smaller than that of the first sub-pixel electrode 191a so as to reduce a deformation in the lateral side mixture gamma curve.

When one horizontal period or 1H (a period of horizontal synchronization signals Hsync and data enable signals DE) passes by, the data driver 500 and the gate driver 400 repeat the same operation with respect to the next row of sub-pixels PXa and PXb. In this way, the gate-on voltages Von are sequentially applied to all the gate lines G1-Gn for one frame, thereby applying the data voltages to all the sub-pixels PXa and PXb. When one frame is terminated, the next frame starts, and the reverse signals RVS applied to the data driver 500 are controlled such that the polarity of the data voltage applied to the respective sub-pixels PXa and PXb is opposite to that in the previous frame (“frame inversion”).

In addition to the frame inversion, the data driver 500 inverts the polarities of the data voltages flowing through the data line neighbors D1-D2m within one frame, and accordingly, the polarities of the sub-pixel voltages are also varied upon receipt of the data voltages. However, the polarity inversion pattern at the data driver 500 and the polarity inversion pattern of the sub-pixel voltages on the screen of the liquid crystal panel assembly 300 are differentiated depending upon the interconnection between the data driver 500 and the data lines D1-D2m. The inversion at the data driver 500 will be referred to hereinafter as “driver inversion,” and the inversion on the screen as “apparent inversion.” For explanatory convenience, the polarity of the sub-pixel voltage at the sub-pixel PXa or PXb will be referred to simply as the “polarity of the sub-pixel PXa or PXb,” and the polarity of the pixel PX as the “polarity of the pixel PX.”

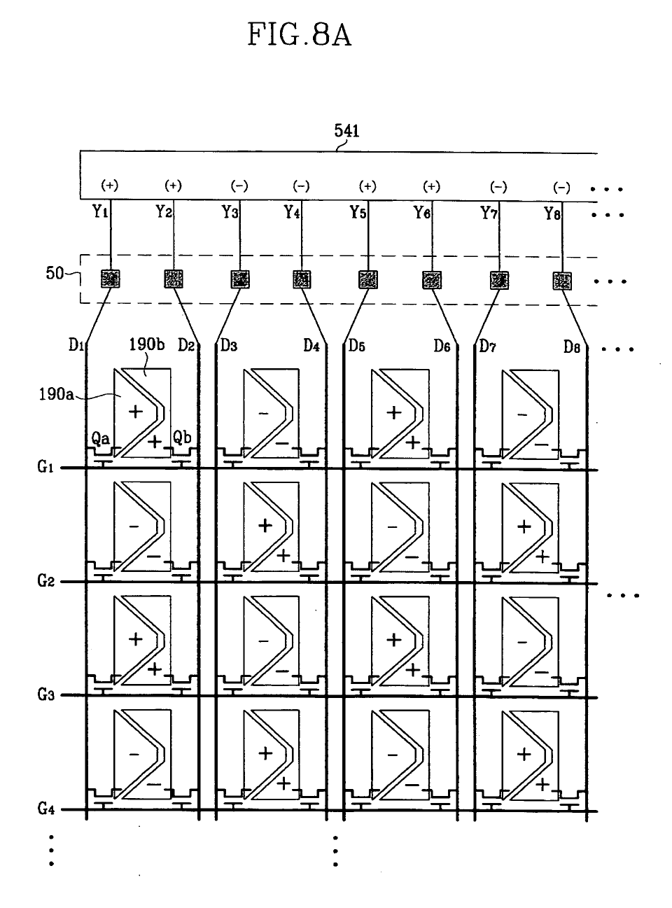

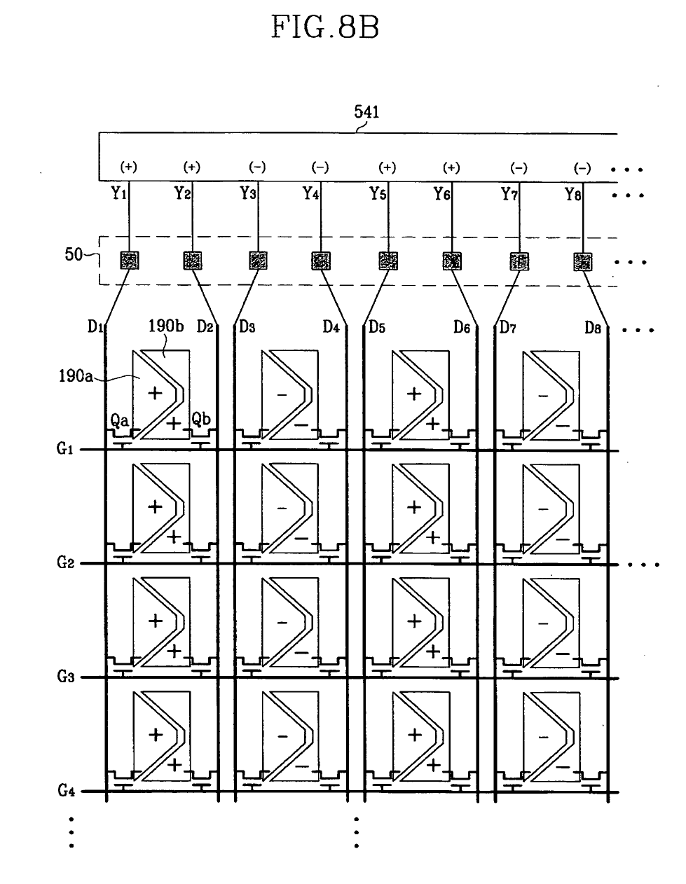

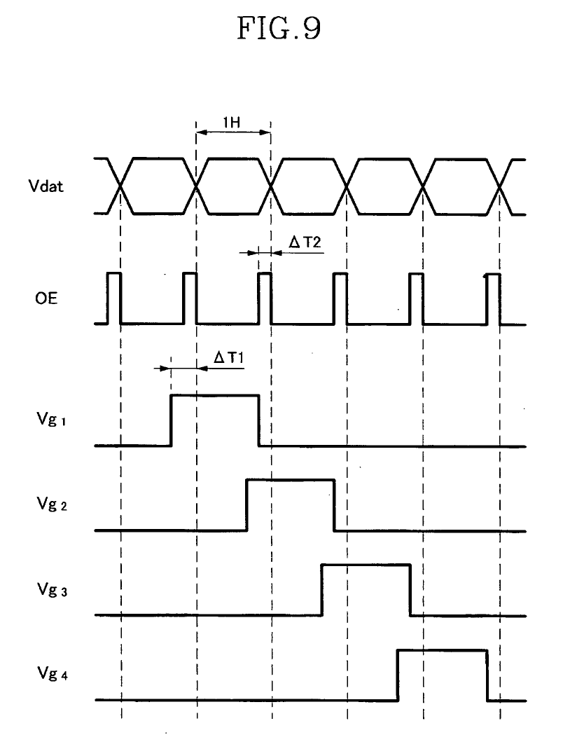

The driver inversion and the apparent inversion with the LCD according to the present embodiment will be now specifically explained with reference to FIGS. 8A to 9. FIGS. 8A and 8B schematically illustrate the driver inversion and the apparent inversion with an LCD according to an embodiment of the present invention, and FIG. 9 is a timing diagram of various signals of an LCD according to an embodiment of the present invention. As shown in FIGS. 8A and 8B, the data driver 500 of FIG. 1 is formed with a data driving IC 541, and the output terminals Y1-Y2m of the data driving IC 541 are connected to the data lines D1-D2m via data pads 50 of the liquid crystal panel assembly 300.

The data driving IC 541 outputs polarity-inverted data voltages to the data lines every two output terminals Y1-Y2m, and accordingly, the polarities of the data voltages flowing through the two data lines (for instance, D1 and D2) connected to a pair of the sub-pixels PXa and PXb are the same, and the polarities of a pair of the sub-pixels PXa and PXb forming one pixel PX are the same. However, the polarities of the data voltages flowing through the two data lines (for instance, D2 and D3) placed between the two pixel neighbors PX are opposite to each other, and hence, the polarities of the pixels PX neighboring each other in the horizontal direction are different from each other.

As shown in FIG. 8A, the data driving IC 541 inverts the polarity of the data voltage for respective pixel rows, and accordingly, the pixels Px neighboring each other in the vertical direction are opposite in polarity to each other. Consequently, the pixels PX have a dot inversion pattern. As shown in FIG. 8B, the data driving IC 541 outputs data voltages with the same polarity to the respective output terminals Y1-Y2m for one frame, and accordingly, the pixels PX neighboring each other in the vertical direction have the same polarity. Consequently, the pixels PX have a column inversion pattern.

Alternatively to the operation just described, if the polarity of the data voltage is inverted for the respective data lines D1-D2m and for the respective pixel rows so that the sub-pixels have a dot inversion pattern, the same polarity may appear for the respective pixel rows. According to such an alternative, the image data is displayed with relatively low grays and the polarity of the sub-pixel PXa receiving the relatively low data voltage does not influence the polarity of the pixel PX. However, the polarity of the sub-pixel PXb receiving the relatively high data voltage does influence the polarity of the pixel PX. Accordingly, the substantial inversion pattern of the pixels PX depends upon the polarities of the sub-pixels PXb to thereby cause row inversion.

Similarly, in the case that the polarity of the data voltage is inverted for the respective data lines D1-D2m and the polarities of the data voltages flowing through one data line for one frame is the same so that the sub-pixel has a column inversion pattern, all the pixels PX for one frame may have substantially the same polarity. Accordingly, as the same polarity appears at the pixels PX of one row or one frame in both of the two cases, flicker or crosstalk is liable to be generated. However, as with the structure according to the present embodiment, the polarities of a pair of the sub-pixels PXa and PXb forming one pixel PX are established to be the same, and hence, all the pixels PX have a dot inversion or column inversion pattern, thereby preventing the flicker or crosstalk from being generated.

The gate signal comes to be a gate-on voltage Von after the data voltage Vdat is applied within 1H, and to be a gate-off voltage Voff when the output enable signal OE is in a high level. The neighboring gate-on voltages Von are not overlapped with each other. However, in the case that the driving is done with the inversion pattern shown in FIG. 8B, the polarities of the data voltages flowing through one data line are the same for one frame, and hence, the neighboring gate signals may be overlapped with each other. Accordingly, as shown in FIG. 9, the time interval of application of the gate-on voltages Von of the gate signals Vg1-Vgn (referred to hereinafter as the gate-on time) may be increased. That is, the time point of application of the gate-on voltage Von at the relevant pixel row is advanced to overlap it with the 1H section of the previous pixel row (ΔT1), or the high leveled width (ΔT2) of the output enable signal OE is maximally reduced, or the output enable signal OE is removed. In this way, in the case that the gate-on time is sufficiently increased, a suitable driving margin can be obtained even if the device is a high resolution LCD or if the frame frequency is 120 Hz. The data driver 500 may be realized with a plurality of data driving ICs, and in such a case, the driver inversion and the apparent inversion are made in the same way.

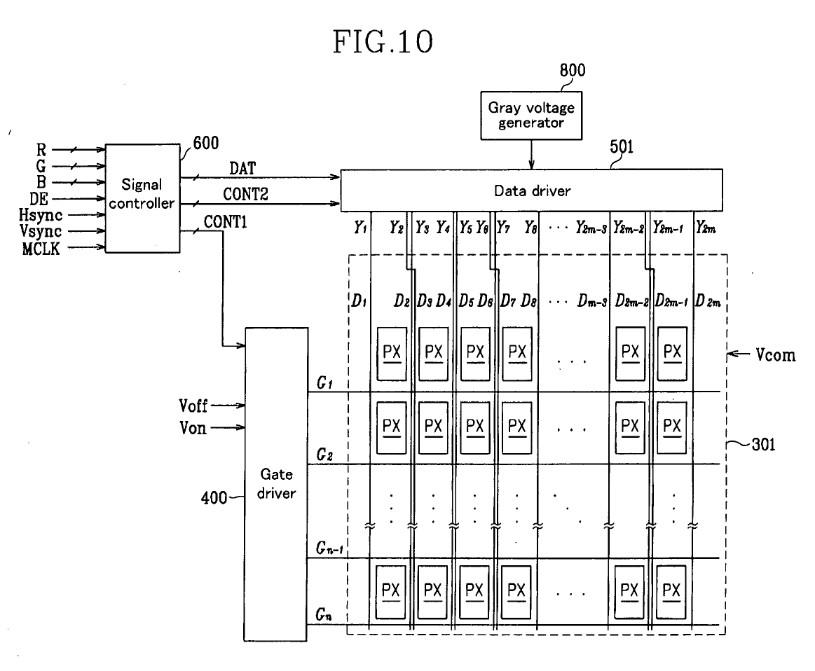

An LCD according to another embodiment of the present invention will be now specifically explained with reference to FIGS. 10 to 13B. As shown in FIG. 10, the LCD according to the present embodiment includes a liquid crystal panel assembly 301, gate and data drivers 400 and 501 connected to the liquid crystal panel assembly 301, a gray voltage generator 800 connected to the data driver 501, and a signal controller 600 for controlling them. As the LCD is substantially the same as the LCD shown in FIG. 1 except for the liquid crystal panel assembly 301 and the data driver 501, explanation of similar structural components will be omitted, and only different structures will be explained.

The liquid crystal panel assembly 301 includes a plurality of gate lines G1-Gn, a plurality of data lines D1-D2m, and a plurality of pixels PX connected thereto. The data driver 501 has a plurality of output terminals Y1-Y2m. The data lines D1, D4, D5, D8, . . . , D2m-3, and D2m are connected to the output terminals Y1, Y4, Y5, Y8, . . . , Y2m-3, and Y2m of the data driver 501, respectively. The data lines D2 and D3 are connected to the output terminals Y3 and Y2 in a crossed manner, and the data lines D6 and D7 are also connected to the output terminal Y7 and Y6 in a crossed manner. This connection structure is continuously repeated.

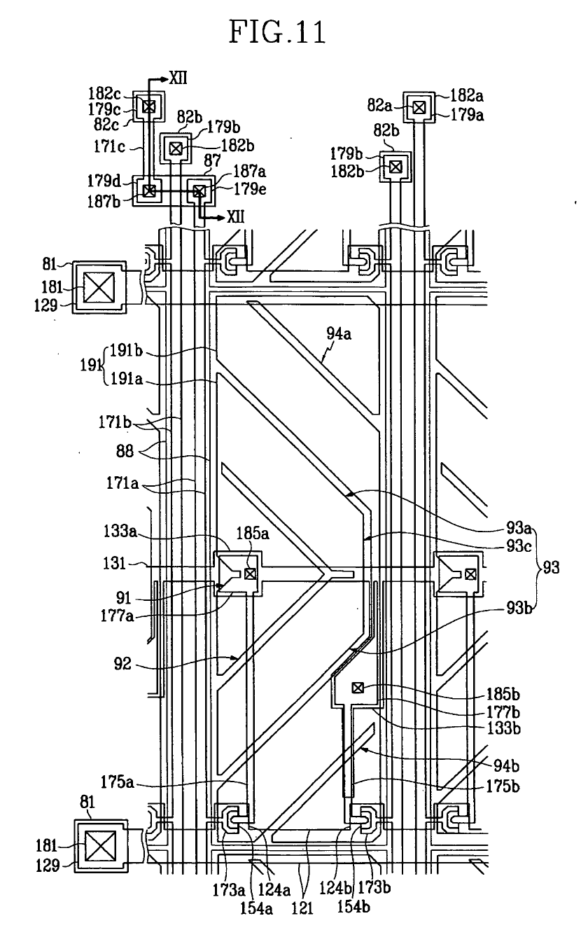

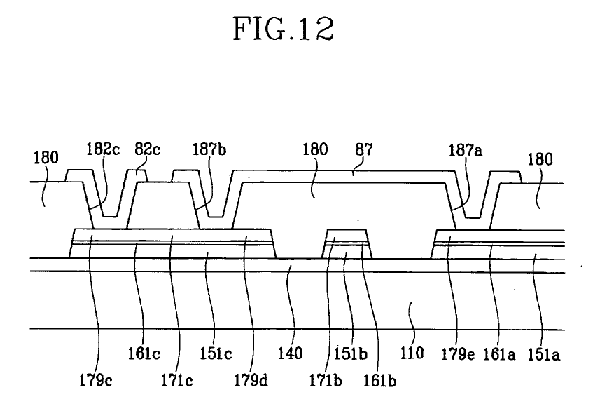

An example of such a liquid crystal panel assembly will be specifically explained with reference to FIGS. 11 and 12. As the thin film transistor panel shown in FIG. 11 is substantially the same as that shown in FIG. 4 except for the area of the end portions of the data lines 171a, explanation of similar structural components will be omitted, and only different structures will be explained.

A plurality of linear-shaped semiconductors 151a and 151b and island-shaped semiconductors 151c are formed on a gate insulating layer 140 with hydrogenated amorphous silicon or polysilicon. A plurality of linear-shaped and island-shaped ohmic contacts 161a, 161b, 161c, 165a, and 165b are formed on the semiconductors 151a, 151b, and 151c with silicide or n+ hydrogenated amorphous silicon where n-type impurities such as phosphorous are doped at a high concentration. Pairs of first and second data lines 171a and 171b, data line extensions 171c, and pairs of first and second drain electrodes 175a and 175b are formed on the ohmic contacts 161a, 161b, 161c, 165a, and 165b and the gate insulating layer 140.

The first data line 171a includes a plurality of source electrodes 173a extended toward the first gate electrodes 124a. One of the first and second data lines 171a and 171b has an end portion 179a amplified in width to make a connection with an external driving circuit, and the other has an end portion 179e amplified in width to make a connection with another layer. The data line extension 171c extends vertically, and has end portions 179c and 179d amplified in width to make a connection with an external driving circuit and another layer. A passivation layer 180 is formed on the data lines 171a and 171b, the data line extensions 171c, the drain electrodes 175a and 175b, and the exposed portions of the semiconductors 151a and 151b.

A plurality of contact holes 182a, 187a, 182b, 185a, and 185b are formed at the passivation layer 180 such that they expose the end portions 179a, 179e, and 179b of the data lines 171a and 171b, and the extensions 177a and 177b of the drain electrodes 175a and 175b, respectively. Furthermore, a plurality of contact holes 182c and 187b are formed at the passivation layer 180 such that they expose the end portions 179c and 179d of the data line extension 171c, respectively. A plurality of contact holes 181 are formed at the passivation layer 180 and the gate insulating layer 140 such that they expose the end portions 129 of the gate lines 121.

A plurality of pixel electrodes 191 with first and second sub-pixel electrodes 191a and 191b, shielding electrodes 88, a plurality of contact assistants 81, 82a, 82b, and 82c, and a plurality of connectors 87 are formed on the passivation layer 180. They are formed with a transparent conductive material such as ITO and IZO, or a reflective metallic material such as aluminum, silver, and alloys thereof. The connector 87 interconnects the data line 171a and the data line extension 171c through the contact holes 187a and 187b. Consequently, the data voltage applied to the data line extension 171c is transmitted to the data line 171a.

It is explained with the present embodiment that the first data line 171a rides over the second data line 171b and is connected to an external driving circuit via the connector 87, but it is also possible that the second data line 171b rides over the first data line 171a and is connected to an external driving circuit.

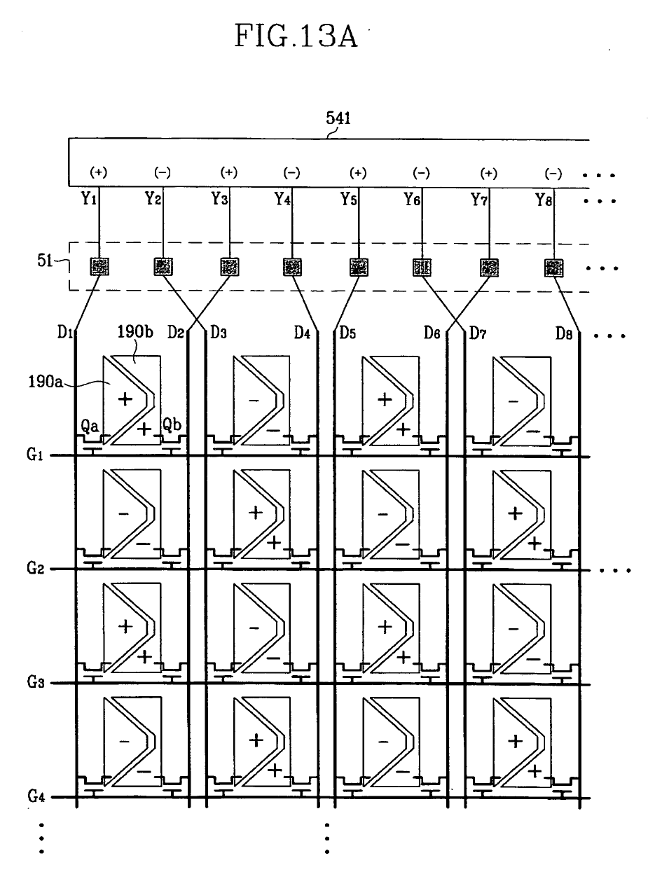

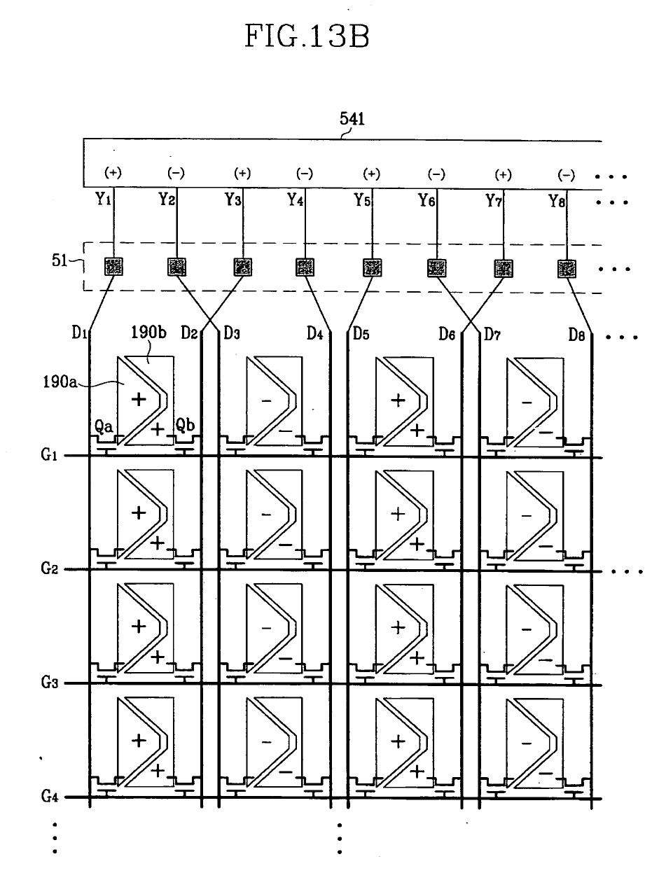

The driver inversion and the apparent inversion with the LCD will now be specifically explained with reference to FIGS. 13A and 13B. As shown in FIGS. 13A and 13B, the data driver 501 of FIG. 10 is formed with a data driver IC 541, and the output terminals Y1-Y2m of the data driving IC 541 are connected to the data lines D1-D2m through data pads 51 of the liquid crystal panel assembly 301. As explained earlier, the data lines D2, D3, D6, D7, . . . , D2m-2 and D2m-1 are connected to the relevant output terminals of the data driving IC 542 in a crossed manner.

The data driving IC 541 outputs data voltages that are inverted in polarity to the respective output terminals Y1-Y2m, and the data voltages that are inverted in polarity every two data lines flow through the partially crossed data lines D1-D2m. Consequently, the data voltages flowing through the two data lines (for example, D1 and D2) that are connected to a pair of the sub-pixels PXa and PXb have the same polarity, and a pair of the sub-pixels PXa and PXb forming one pixel PX have the same polarity. However, the polarities of the data voltages flowing through the two data lines (for example, D2 and D3) disposed between the two pixel neighbors PX are opposite to each other, and hence, the pixels PX neighboring each other in the horizontal direction are different in polarity from each other.

As shown in FIG. 13A, the data driving IC 541 inverts the polarity of the data voltage for the respective pixel rows, and accordingly, the polarities of the pixels PX neighboring each other in the vertical direction are opposite to each other so that the pixels PX have a dot inversion pattern.

As shown in FIG. 13B, the data driving IC 541 outputs the data voltages with the same polarity to the respective output terminals Y1-Y2m for one frame, and accordingly, the pixels PX neighboring each other in the vertical direction have the same polarity so that the pixels PX have a column inversion pattern. In this way, if a pair of the sub-pixels PXa and PXb forming one pixel PX have the same polarity, the pixels PX has a dot inversion or column inversion pattern, thereby preventing the flicker or crosstalk from being generated.

Furthermore, in the case that the driving is done with the inversion pattern shown in FIG. 13B, the gate signals are overlapped with each other to thereby elongate the gate-on time, in the way illustrated in FIG. 9. Many features concerning the LCD shown in FIGS. 1 to 9 may be applied to the LCD shown in FIGS. 10 to 13B.

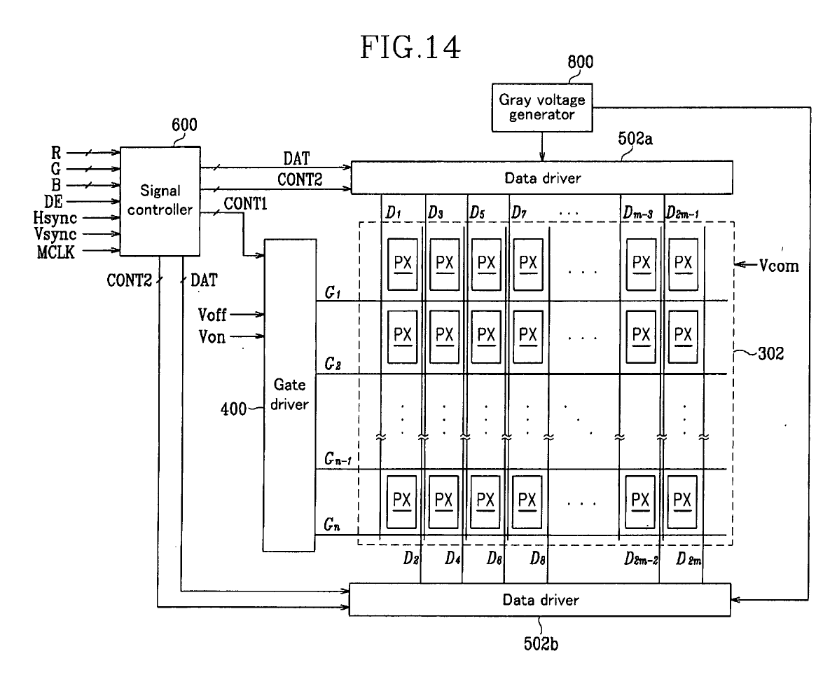

An LCD according to another embodiment of the present invention will now be specifically explained with reference to FIGS. 14 to 16B. As shown in FIG. 14, the LCD according to the present embodiment includes a liquid crystal panel assembly 302, a gate driver 400 and a pair of data drivers 502a and 502b connected to the liquid crystal panel assembly 302, a gray voltage generator 800 connected to the data drivers 500a and 502b, and a signal controller 600 for controlling them. The LCD according to the present embodiment is substantially the same as the LCD shown in FIG. 1 except for the liquid crystal panel assembly 302 and the data drivers 502a and 502b. Therefore, explanation of similar structural components will be omitted, and only different structures will now be explained.

The liquid crystal panel assembly 302 includes a plurality of gate lines G1-Gn, a plurality of data lines D1-D2m, and a plurality of pixels PX connected thereto. A pair of data drivers 502a and 502b are placed at the upper and lower portions of the liquid crystal panel assembly 302 and are connected to the odd-numbered and the even-numbered data lines D1-D2m, respectively.

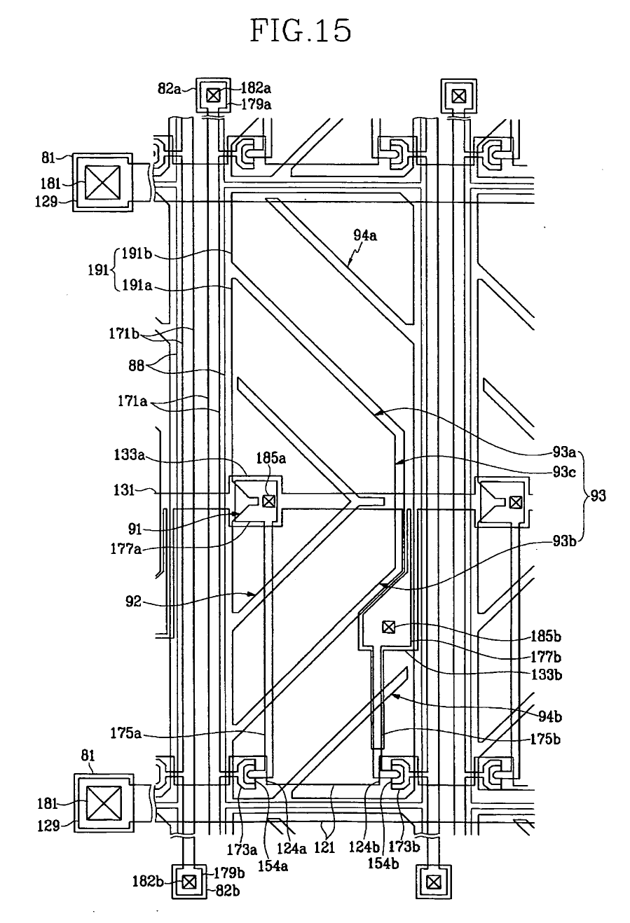

An example of such a liquid crystal panel assembly will now be explained with reference to FIG. 15. As shown in FIG. 15, the thin film transistor panel according to the present embodiment is substantially the same as that shown in FIG. 4 except for the area of the end portions of the data lines 171b, and hence, explanation of similar structural components will be omitted, while only different structures will now be explained. As shown in FIG. 15, the first and second data lines 171a and 171b include end portions 179a and 179b placed at the top and the bottom ends of the thin film transistor panel and amplified in width to make a connection with other layers or external driving circuits. Accordingly, the contact assistants 82a and 82b are also placed at the top and the bottom ends of the thin film transistor panel, and are connected to the end portions 179a and 179b of the data lines 171a and 171b through the contact holes 182a and 182b, respectively.

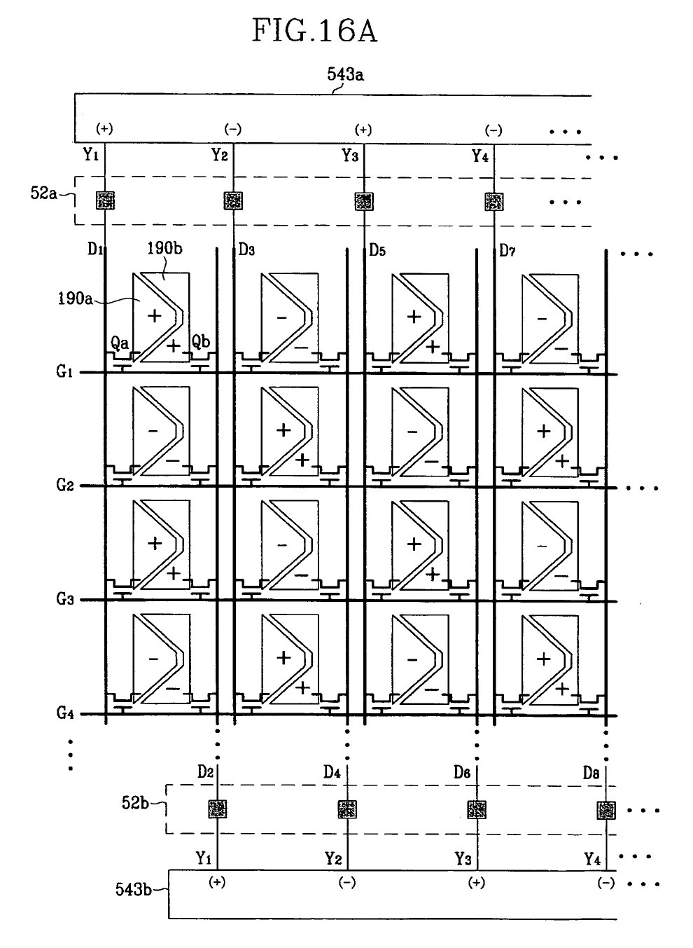

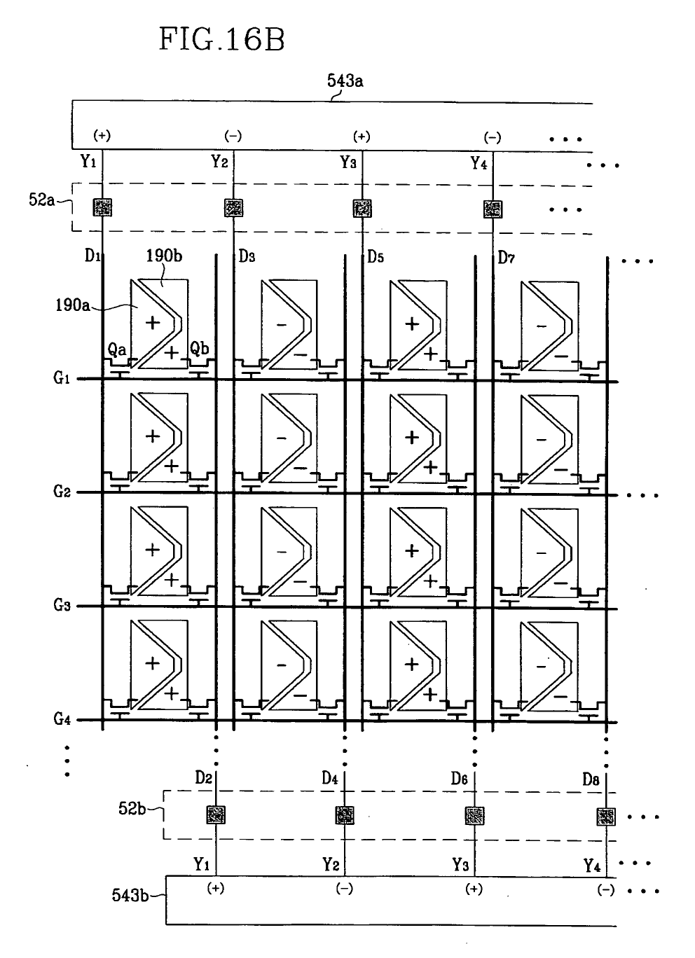

The driver inversion and the apparent inversion with the LCD will be specifically explained with reference to FIGS. 16A and 16B. As shown in FIGS. 16A and 16B, a pair of data drivers 502a and 502b of FIG. 14 are formed with upper and lower data driving ICs 543a and 543b, and the output terminals Y1-Ym of the upper data driving IC 543a are connected to the data lines D1, D3, D5, . . . , and D2m-1 through upper data pads 52a of the liquid crystal panel assembly 302, and the output terminals Y1-Ym of the lower data driving IC 543b are connected to the data lines D2, D4, D6, . . . , and D2m through lower data pads 52b of the liquid crystal panel assembly 302.

The respective data driving ICs 543a and 543b output data voltages that are inverted in polarity to the respective output terminals Y1-Ym, and the data voltages that are inverted in polarity every two data lines flow through the data lines D1-D2m. Consequently, the data voltages flowing through two data lines (for example, D1 and D2) connected to a pair of sub-pixels PXa and PXb have the same polarity, and the polarities of the sub-pixels PXa and PXb forming one pixel PX are the same. However, the polarities of the data voltages flowing through the two data lines (for example, D2 and D3) disposed between the two neighboring pixels PX are opposite to each other, and hence, the pixels PX neighboring each other in the horizontal direction are different in polarity from each other.

As shown in FIG. 16A, the respective data driving ICs 543a and 543b invert the polarity of the data voltage for the respective pixel rows, and accordingly, the polarities of the pixels PX neighboring each other in the vertical direction are opposite to each other so that the pixels involve a dot inversion pattern. As shown in FIG. 16B, the respective data driving ICs 543a and 543b output data voltages with the same polarity to the respective output terminals Y1-Ym for-one frame, and accordingly, the pixels PX neighboring each other in the vertical direction have the same polarity so that the pixels PX involve a column inversion pattern. In this way, the driving is done with the inversion pattern shown in FIG. 16B, the gate signals are overlapped with each other to thereby elongate the gate-on time, in the way illustrated in FIG. 9. Many features concerning the LCD shown in FIGS. 1 to 9 may be applied to the LCD shown in FIGS. 14 to 16B.

As described above, with the inventive structure, a pixel is divided into a pair of sub-pixels, and the respective sub-pixels are connected to two different data lines. Consequently, different data voltages may be applied to the two sub-pixels to the desired degree, and accordingly, the visibility can be enhanced. Furthermore, data voltages with the same polarity are applied to a pair of sub-pixels, thereby preventing flicker or crosstalk from being generated.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A liquid crystal display comprising:
a plurality of pixels arranged in the form of a matrix and having first and second sub-pixels;
a plurality of gate lines connected to the first and second sub-pixels to transmit gate signals thereto;
a plurality of first and second data lines crossing the gate lines and connected to the first and second sub-pixels to transmit first and second data voltages thereto, respectively; and
a data driver for outputting the first and second data voltages to the first and second data lines, respectively;
wherein the first and second data voltages have the same polarity.

2. The liquid crystal display of claim 1, wherein the first and second data lines are placed at both ends of the pixel, respectively.

3. The liquid crystal display of claim 2, wherein the plurality of first and second data lines are sequentially connected to the data driver.

4. The liquid crystal display of claim 3, wherein the data driver outputs the first and second data voltages such that the polarities of the first and second voltages are inverted for every two output terminals.

5. The liquid crystal display of claim 2, wherein with pairs of first and second data lines disposed between the pixel neighbors, at least a pair of the first and second data lines are connected to the data driver in a crossed manner.

6. The liquid crystal display of claim 5, wherein the data driver outputs the first and second data voltages such that the polarities of the first and second data voltages are inverted for each consecutive output terminal.

7. The liquid crystal display of claim 2, wherein the data driver comprises first and second data drivers connected to the first and second data lines, respectively.

8. The liquid crystal display of claim 7, wherein the pixels are disposed between the first and second data drivers.

9. The liquid crystal display of claim 8, wherein the first and second drivers output the first and second data voltages such that the polarities of the first and second voltages are inverted for each consecutive output terminal.

10. The liquid crystal display of any one of claims 4, 6, and 9, wherein the polarities of the first and second data voltages applied to the first and second data lines disposed between pixel neighbors are opposite to each other.

11. The liquid crystal display of claim 10, wherein the first and second data voltages flowing through the first and second data lines have the same polarity.

12. The liquid crystal display of claim 11, wherein gate-on voltages applied to gate line neighbors are overlapped with each other.

13. The liquid crystal display of claim 12, wherein a time interval of application of the gate-on voltages is longer than one horizontal period.

14. The liquid crystal display of claim 10, wherein the polarities of the first and second data voltages flowing through the first and second data lines are inverted for each consecutive pixel row.

15. The liquid crystal display of claim 1 wherein the first and second data voltages are different in dimension from each other, and are obtained from one image information data.
